(19) United States
(12) Patent Application Publication
(10) Pub. No.: US 2004/0101665 A1
(43) Pub. Date: May 27, 2004

(54) Direct patterning method

(75) Inventors: Masaru Seita, Kitaadachi-gun (JP); Hideki Tsuchida, Hasuda-shi (JP); Masaaki Imanari, Misato-shi (JP); Hidemi Nawafune, Takatsuki-shi (JP); Koichi Yomogida, Saitama-shi (JP)

Correspondence Address: EDWARDS & ANGELL, LLP, P.O. Box 9169, Boston, MA, 02209, US

(73) Assignee: Shipley Company, L.L.C., Marlborough, MA

(21) Appl. No.: 10/650,119

(22) Filed: Aug. 26, 2003

Related U.S. Application Data
(60) Provisional application No. 60/406,255, filed on Aug. 26, 2002.

(30) Foreign Application Priority Data
Feb. 14, 2001 (JP) 2001-36501

(51) Int. Cl. B05D 3/00; B32B 15/08

(52) U.S. Cl. 428/209; 427/553; 428/457

(57) ABSTRACT

A composite material having metal at the surface of a resin base is obtained by subjecting the surface of a resin base to ion exchange group introduction treatment, treating the surface of said resin base with liquid containing metal ions to introduce metal ions, introducing photocatalyst into the resin base containing said introduced metal ions, and then irradiating the resin base with electromagnetic radiation after said photocatalyst introduction. Said composite material is useful for composite materials that require fine metal patterns.

The present application claims the benefit of U.S. provisional application No. 60/406,255, filed Aug. 26, 2002, which is incorporated herein by reference in its entirety.

### BACKGROUND

1. Field of the Invention

The present invention relates to a resin composite material having metal at the surface of a resin base, and in particular, relates to a resin composite material in which the metal forms a metal pattern, and a method for forming the aforementioned resin composite material.

2. Background

In recent years, technological innovation in fields such as electronics and electronic devices has been advancing dramatically. Along with these advances has developed the demand for increasingly fine conductor patterns in resin-metal composite materials such as printed circuit boards used in electronic devices and electronic components. In the past, electroless plating treatments have been carried out in order to form metal patterns on resin bases, and with such methods, it is possible to obtain metal patterns at a pitch of about 100 μm at mass production levels.

Resin composite materials in which a metal coating is formed on a resin base by means of an electroless plating treatment have low binding strength between resin base and metal. Thus, ordinarily, the surface of the resin base is treated with a chemical agent such as chromic acid or permanganic acid as a pretreatment in order to improve binding. Thus, etching treatments are required in order to form bumps that provide an anchoring effect on the surface of the resin base. Pattern height has been decreasing along with decreasing pitches in metal patterns formed on resin bases. Along with this reduction in pattern height, the ratio of the bumps on the resin base with respect to the height of the metal pattern has increased, leading to problems with detrimental influences on the electrical characteristics of the metal pattern, or the inability to form metal patterns.

If the pitch of the metal pattern is about 100 μm as described above, the metal pattern height can be maintained to some degree, and there are thus no serious problems when bumps are formed on the resin base required for the electroless plating treatment. When the pattern pitch is to be less than 100 μm, however, the height of the metal pattern decreases, and the bumps on the resin base required for the electroless plating treatment will have a detrimental effect.

In addition, with the semi-additive method which is a conventional metal pattern formation method, a metal coating is formed on a resin base, which is subsequently used as a mask, and an operation is carried out wherein etching is performed to produce the desired pattern. For this reason, the metal in regions other than the metal pattern regions is superfluous, resulting in increased costs as the number of treatment processes increases, as well as problems with time required for manufacture. In addition, with the full-additive method, although metal pattern is formed directly by means of an electroless treatment, it is necessary to form a pattern with a plating resist prior to the electroless plating treatment, which increases the number of treatment processes. In electroless plating treatments, it is necessary to affix catalyst to the resin base, and so there are problems with residual catalyst in regions other than the metal pattern region. Electroless plating treatments also employ carcinogenic substances such as formalin, which cause problems with poor work environment for humans, as well as environmental pollution resulting from electroless plating treatment waste liquids. In general, electroless plating treatments pose problems in that they are lengthy due to the need for numerous processes, and in that management of electroless plating treatment liquids is difficult.

A method for resolving the above disadvantages with electroless plating treatments involves subjecting the surface of a resin base to an ion exchange group introduction treatment, introducing metal ions by treating the surface of said resin base with liquid containing metal ions, and reducing said metal ions to form a composite material having metal at the surface of the resin base (referred to below as “direct metallization”). In this method, the reducing treatment can involve irradiation with patterned electromagnetic radiation, thus forming the metal pattern on the resin base. However, the efficiency of electromagnetic radiation in the reduction of metal ions to metals is comparatively poor, and there are cases where metal pattern formation is incomplete due to inadequate reduction. In particular, in cases where divalent copper ions are reduced to copper, there is a strong tendency for inadequate pattern formation to occur when metal ions having valences of two or greater are reduced to metals.

### SUMMARY OF THE INVENTION

For this reason, as a substitute for composite material formation methods that begin with electroless plating treatments, a method for introducing metal onto resin base is desired whereby a resin-metal composite material with excellent binding between resin base and metal can be formed easily and efficiently. In particular, a method is desired in which metal is introduced onto a resin base and a fine metal pattern can be readily and efficiently formed with superior binding between metal and resin base without the formation of large bumps on the resin base surface.

Moreover, a method is desired wherein, in the aforementioned direct metallization methods that involve irradiation with activating radiation (e.g. electromagnetic radiation), said metal ions are reduced with good efficiency, thus forming a good metal pattern even when metal ions having valences of two or greater are introduced onto the resin base.

In addition, a metal-resin composite material is desired that not only has excellent binding between metal and resin base, but also has a fine metal pattern.

In light of this state of affairs, the present invention has the objective of offering a method for the efficient manufacture of composite materials with excellent binding between metal and resin base, where the resin base surface at the joining region between the resin base and metal is smooth, and in particular, a method for manufacturing the aforementioned composite material having a fine metal pattern. Moreover, the present invention has the objective of offering a method for manufacturing composite materials having good metal patterns, wherein, in direct metallization methods that involve irradiation with electromagnetic radiation, said metal ions are reduced with good efficiency, even in cases where metal ions with valences of two or greater are used.

In addition, the present invention has the objective of offering a composite material that is manufactured by the aforementioned methods, and in particular, a composite material having metal on the surface of a resin base, with a photocatalyst in or on said metal.

The present invention offers a method for forming a composite material, comprising (1) a process for introducing ion exchange groups into the surface of a resin base, (2) a process for introducing metal ions by treating the surface of said resin base with liquid containing metal ions, (3) a process for introducing optical catalyst into the resin base having the introduced metal ions, and (4) a process for forming metal on the surface of the resin base by using electromagnetic radiation to irradiate the resin base having said introduced photocatalyst.

In another aspect, methods for forming a composite material are provided comprising (a) introducing ion exchange groups to resin base, (b) introducing metal ions to the resin base; (c) introducing a photocatalyst into the resin base, and forming metal on the surface of a resin base. Preferably, those steps (a) through (c) are conducted sequentially.

In addition, the present invention offers a composite material wherein metal is present on a resin base and a photocatalyst is present in or on said metal, and in particular, the aforementioned composite material wherein the joining strength between the resin base and metal is at least about 5 or 10 N/cm, such as 5-15 N/cm.

Other aspects of the invention are discussed infra.

### DETAILED DESCRIPTION OF THE INVENTION

In one aspect, the present invention offers a composite material wherein metal is present at the surface of a resin base that is obtained by subjecting the surface of a resin base to an ion exchange group introduction treatment, treating said resin base surface with liquid containing metal ions to introduce metal ions, introducing a photocatalyst into the resin base containing said metal ions, and irradiating the resin base with activating radiation (e.g. electromagnetic radiation) after introducing said photocatalyst.

The resin base that can be used in the composite material of the present invention can be any resin, provided that it has appropriate physical properties relative to the objectives of use, for example, good strength and corrosion resistance. The resin base can have any shape, without any particular restrictions. In addition, the resin base that can be used in the present invention is not restricted to resin moldings, as composite materials can also be used that are produced by introducing reinforcing material such as glass fiber within the resin. Alternatively, materials produced by coating resins onto bases composed of various elements such as ceramics, glasses and metals can also be used.

Any resin can be used for the resin base, and examples include high-density polyethylene, medium-density polyethylene, branched low-density polyethylene, linear low-density polyethylene, ultra-high-molecular-weight polyethylene and other polyethylene resins, polypropylene resin, polybutadiene, polybutene resin, polybutylene resin, polystyrene resin and other polyolefin resins; polyvinyl chloride resin, polyvinylidene chloride resin, polyvinylidene chloride-vinyl chloride copolymer resin, polyethylene chloride, polypropylene chloride, tetrafluoroethylene and other halogenated resins; AS resin; ABS resin; MBS resin; polyvinyl alcohol resin; polymethyl acrylate and other polyacrylate ester resins; polymethyl methacrylate and other polymethacrylate ester resins; methyl methacrylate-styrene copolymer resins; maleic anhydride-styrene copolymer resins; polyvinyl acetate resins; cellulose propionate resins, cellulose acetate resins and other cellulose resins; epoxy resin; polyimide resin; nylon and other polyamide resins; polyamidoimide resins; polyacrylate resin; polyether imide resin; polyester ether ketone resin; polyethylene oxide resin; PET resin and various other polyester resins; polycarbonate resin; polysulfone resin; polyvinyl ether resin; polyvinyl butyral resin; polyphenylene oxide and other polyphenylene ether resins; polyphenylene sulfide resin; polybutylene terephthalate resin; polymethylpentene resin; polyacetal resin; vinyl chloride-vinyl acetate copolymer; ethylene-vinyl acetate copolymer; ethylene vinyl chloride copolymer; and other copolymer and blended thermoplastic resins, epoxy resin; xylene resin; guanamine resin; diallylphthalate resin; vinyl ester resin; phenol resin; unsaturated polyester resin; furan resin; polyimide resin; polyurethane resin; maleic acid resin; melamine resin; urea resin; and other thermosetting resins, as well as mixtures thereof. However, examples are not restricted to these. Preferred resins are epoxy resin, polyimide resin, vinyl resin, phenol resin, nylon resin, polyphenylene ether resin, polypropylene resin, fluorine-based resin and ABS resin, with preferred examples being epoxy resin, polyimide resin, polyphenylene ether resin, fluorine-based resin and ABS resin, with epoxy resin and polyimide resin being additionally desirable. The resin base can be composed of individual resins, or can be composed of multiple resins. In addition, the surface that is treated with ion exchange group introduction agent need not be the resin base, as the base can be a composite formed by applying or laminating a resin onto another base.

The metal that is introduced into the resin base in the composite material of the present invention can be a metal composed of an individual metal element, or an alloy composed of two or more metal elements. In regard to the metal, the aforementioned alloy can take various forms, e.g., forms in which multiple metal elements form a solid solution, forms in which a non-crystalline body is formed from a mixed body of component metals comprising various metal elements, or forms in which these are combined. Examples of said metal include metals selected from a group comprising the metals Sc, Ti, V, Cr, Mn, Fe, Co, Ni, Cu, Zn, Ga, Ge, As, Se, Y, Zr, Nb, Mo, Tc, Ru, Rh, Pd, Ag, Cd, In, Sb, Te, Hf, Ta, W, Re, Os, Ir, Pt, Au, Hg, Tl, Pb, Bi, Po and alloys thereof. Preferred metals are those selected from the metals V, Cr, Mn, Fe, Co, Ni, Cu, Ga, As, Se, Mo, Ru, Rh, Pd, Ag, Cd, In, Sb, Te, Os, Ir, Pt, Au, Hg, Pb, Bi and alloys thereof. Additionally desirable metals are those selected from a group comprising the metals V, Mn, Co, Ni, Cu, Ga, As, Se, Mo, Pd, Ag, In, Sb, Te, Pt, Au, Hg, Bi and alloys thereof. Additionally desirable metals are those selected from a group comprising the metals Co, Ni, Cu, Pd, Ag, Pt, Au and alloys thereof. Even more desirable metals are those selected from a group comprising the metals, Co, Ni, Cu and alloys thereof.

The metal that is introduced into the resin base in the composite material of the present invention can be present in any form on the base. For example, the metal can be present as fine grains isolated from each other on the substrate surface, or can be a material that forms coating or network structures, or combinations thereof. Various configurations can be determined appropriately, e.g., the particle diameter and particle distribution when the material is a particulate, or the coating thickness when a coating is formed. The mode of introduction of the component containing metal elements can be adjusted appropriately depending on whether each of the processes is repeated a number of times, and depending on the various conditions of the processes whereby the composite material having metal at the surface of the resin base is formed.

In a mode of the present invention, a metal pattern can be formed on the resin base. Said metal pattern can function as conductor, etc. on the resin base. In the present invention, the pitch of the metal pattern is 100-10 μm, with 75-20 μm being preferred, 50-20 μm being additionally desirable, and 30-20 μm being even more desirable. In this specification, the range of values used for expressing metal pattern pitch are values for the finest regions in the metal pattern. If the pitch of the finest region is within the above ranges, then the material is within the scope of the present invention, even if the metal pattern of the composite material has regions with pitches that are greater than the above ranges. A pattern of any shape such as a line/land pattern can be used for the metal pattern in the present invention, and various shapes can be mixed.

The surface of the composite material formed by the introduction of metal on the resin base has various useful characteristics such as conductivity, semiconductor properties, magnetic properties and non-charging properties in accordance with the type, amount and introduction mode of the metal. In addition, when the metal forms a coating, the material has various useful characteristics as a conductive coating, semiconductor coating, or magnetic coating in accordance with the type of the metal, or in accordance with the condition of the alloy if the metal is an alloy. From the standpoint of utility as a magnetic coating, it is preferable for the metal coating to comprise alloys such as Co—Ni, Co—Cr, Co—V, Ni—Mo—Fe, Gd—Co, Mn—Bi, Mn—Cu—Bi, Pt—Co or Co—Cr.

In the present invention, the aforementioned metal and the aforementioned resin that are used in the resin base can be freely selected. When the component containing metal element is a metal, the combination of metal and resin preferably comprises a resin selected from a group comprising epoxy resin, polyimide resin, vinyl resin, phenol resin, nylon resin, polyphenylene ether resin, polypropylene resin, fluorine-based resin or ABS resin and mixtures thereof for the resin, and a metal selected from a group comprising V, Mn, Co, Ni, Cu, Ga, As, Se, Mo, Pd, Ag, In, Sb, Te, Pt, Au, Hg, Bi and alloys thereof for the metal. It is additionally desirable for the resin to be a resin selected from a group comprising epoxy resin, polyimide resin, vinyl resin, phenol resin, nylon resin, polyphenylene ether resin, polypropylene resin, ABS resin and mixtures thereof, and for the metal to be a metal selected from a group comprising V, Mn, Co, Ni, Cu, Ga, As, Se, Mo, Pd, Ag, In, Sb, Te, Pt, Au, Hg, Bi and alloys thereof. It is further desirable for the resin to be a resin selected from a group comprising epoxy resin, polyimide resin, polyphenylene ether resin, ABS resin and mixtures thereof, and for the metal to be a metal selected from a group comprising V, Mn, Co, Ni, Cu, Ga, As, Se, Mo, Pd, Ag, In, Sb, Te, Pt, Au, Hg, Bi and alloys thereof.

In the composite material of the present invention, the binding strength between the resin base and metal is improved. The term “binding strength” used in this specification refers to the binding strength measured by the peel strength measurement method. Specifically, a copper coating of 10-30 μm is formed by copper sulfate plating or electroless copper plating on the metal of the composite material of the present invention, and after annealing for 1 h at 120° C., the value is measured by a test (180° or 90° peel strength test) wherein said copper coating is cut at a width of 1 cm, and a tensile testers is used in order to pull the coating perpendicularly at a rate of 10 mm/min.

The binding strength between metal and base resin in the composite material of the present invention is generally 1-15 N/cm, with 5-15 N/cm being preferred, 8-15 N/cm being additionally desirable, and 10-15 N/cm being even more desirable. The binding strength of the composite material obtained by the electroless plating treatment is generally less than 1 N/cm.

In the composite material of the present invention, etching of the resin base is not necessary to achieve the aforementioned range of binding properties. For this reason, the average surface roughness of the joining surface between the metal and resin base in the composite material of the present invention is generally 1 μm or less, with 0.1 μm or less being preferred. The average surface roughness is measured according to JISC 6511.

The composite material of the present invention, as described below, is obtained by introducing photocatalyst into the resin base containing introduced metal ions, and then irradiating the resin base with electromagnetic radiation after said photocatalyst has been absorbed. Thus, the photocatalyst can be contained in or on the metal of the resin base, but is preferably contained in the metal. With regard to the amount of photocatalyst after irradiation with electromagnetic radiation, for example, the substance can be introduced so that the amount of photocatalyst is 10⁻⁵ to 10⁻³ mg/cm² in terms of the surface area of metal that coats the resin base. However, the amount of photocatalyst that has been introduced is not restricted to this range. The photocatalyst in the composite material can be released from the composite material in process (6) carried out after electromagnetic irradiation, which can involve various processes such as a plating treatment or etching treatment. For this reason, the upper limit of photocatalyst in the composite material of the present invention, in light of carrying out subsequent treatments, is the amount that is initially introduced, and the lower range is the detection limit when using various types of technologies. For example, the amount of photocatalyst in the composite material of the present invention is 10⁻¹⁰ to 10⁻³ mg/cm², with 10⁻¹⁰ to 10⁻⁴ mg/cm² being preferred and 10⁻¹⁰ to 10⁻⁵ mg/cm² being additionally desirable, in terms of the surface area of the metal that coats the resin base.

There are cases where some of the introduced photocatalyst is converted by the electromagnetic irradiation treatment, process (6) described below, a plating treatment, an etching treatment or various other such treatments. Although conversion of photocatalyst to another compound will differ depending on the treatment that is carried out, metal element derived from photocatalyst will be present in composite material. For example, when TiO₂ is used as photocatalyst, there are cases where Ti element will be present in the metal. The composite material of the present invention has element derived from photocatalyst present in the metal or on the metal surface of the composite material, and in light of this point, the distribution of elements in the catalyst layer in electroless plating formed on the resin base will differ. In this regard, a distinction can be drawn between the composite material of the present invention and metal-resin composite materials formed by means of electroless plating.

The composite material of the present invention, as described below, is characterized in that the surface of the resin base is subjected to an ion exchange group introduction treatment, the surface of said resin base is then treated with liquid containing metal ions to introduce metal ions, whereupon said metal ions are reduced. Thus, the material does not have a catalyst layer between the metal and resin base. When a metal coating is formed on the resin base surface by an electroless plating method, first, the resin base is treated with catalyst composed of Pd and Sn or Cu, thereby forming catalyst nuclei composed of Pd and tin salt or Cu, whereupon the plating metal is deposited with said catalyst nuclei as centers, thus forming the metal coating. In this case, the catalyst layer refers to the layer of catalyst formed on the resin base. It is not necessary for said catalyst to be present in layer form; rather, the catalyst nuclei at the resin surface can be present as isolated points, provided that the catalyst is present on the resin. Consequently, the composite material having the metal coating on the resin base surface obtained by means of an electroless plating method has catalyst nuclei between said resin base and metal coating. In other words, the material has a catalyst layer. On the other hand, in contrast to materials formed by conventional electroless plating, the composite material of the present invention is a material that has no catalyst layer between the resin base and the component containing metal element.

In the composite material of the present invention, the metal that is introduced onto the resin base is present with a more uniform distribution relative to cases where metal is introduced by conventional electroless plating. In addition, when the metal forms a coating, it has a more uniform film thickness relative to composite materials having metal coatings formed by conventional electroless thin film plating. Although a theoretical grasp cannot be expected, the aforementioned advantage of the present invention is thought to result from the fact that the composite material of the present invention does not have a catalyst layer. Specifically, because metal is deposited around catalyst nuclei formed on the resin base in electroless plating, the areas around the catalyst nuclei are thick, and the areas where catalyst nuclei are not present are thin, in terms of the film thickness of the resulting metal coating. Because the distribution of catalyst nuclei in electroless plating is not uniform, sufficiently uniform film thickness is not obtained for film thicknesses of 200 nm or less when the distribution density is low. As a result, it is impossible to control film thickness. On the other hand, the composite material of the present invention does not involve the deposition of metal around catalyst nuclei, and so film thickness non-uniformity resulting from electroless plating techniques does not occur.

The composite material of the present invention can be manufactured by a composite material formation method, which comprises (1) a process in which the surface of the resin base is subjected to an ion exchange group introduction treatment, (2) a process wherein the surface of said resin base is treated with liquid containing metal ions to introduce metal ions, (3) a process wherein photocatalyst is introduced into the resin base containing the introduced metal ions, and (4) a process wherein the resin base containing said introduced catalyst is irradiated with electromagnetic radiation to form metal on the surface of the resin base. These various processes are described in detail below.

Process 1: In the process wherein an ion exchange group introduction treatment is carried out at resin base surface, the resin base is first subjected to an ion exchange group introduction treatment in order to introduce groups having ion exchange capacity into the resin base.

In the present invention, the groups having ion exchange capacity that are introduced by the ion exchange group introduction treatment can be cation exchange groups or anion exchange groups. Examples include carboxyl groups, thiocarboxyl groups, dithiocarboxyl groups, sulfo groups, sulfino groups, sulfeno groups, haloformyl groups, carbamoyl groups, hydrazinocarbonyl groups, amidino groups, cyano groups, nitrilo groups, isocyan groups, cyanato groups, isocyanato groups, thiocyanato groups, isothiacyanato groups, formyl groups, hydroxyl groups, carboxyl groups, thioformyl groups, thioxo groups, mercapto groups, hydropyroxyl groups, amino groups, imino groups, hydrazino groups, diazo groups, azido groups, nitro groups and nitroso groups, but groups are not restricted to these. It is preferable for the groups having ion exchange capacity to be carboxyl groups, hydroxyl groups, carbonyl groups, amino groups, imino groups, cyano groups and nitro groups. With cation exchange groups, ion exchange occurs with cationic metal ions in process (2), and with anion exchange groups, ion exchange occurs with anionic metals in process (2).

Examples of ion exchange group introduction treatments pertaining to the present invention that can be cited are plasma treatment and ion exchange group introduction agent treatment. Plasma treatment or ion exchange group introduction agent treatment can be used for the treatment, or both treatments can be carried out. When both treatments are carried out, the order of the treatments does not matter.

When the ion exchange group introduction treatment is a plasma treatment, the introduction of groups having ion exchange capacity occurs, along with the release of elements constituting the resin (hydrogen extraction, etc.) due to the high-energy active species, and along with branching/cross-linking or de-saturation.

Examples of groups having ion exchange capacity that are introduced by the plasma treatment include oxygen-containing functional groups such as carboxyl groups, hydroxyl groups and carbonyl groups for oxygen plasma or air, nitrogen-containing functional groups such as amino groups, imino groups and cyano groups for ammonia or nitrogen and hydrogen mixed gas plasmas, and functional groups such as nitro groups for nitrogen gas plasma, but examples are not restricted to these. In addition, it is possible to introduce various types of groups having ion exchange capacity using gases other than those mentioned above. Because groups having ion exchange capacity are introduced at the resin surface by means of the plasma treatment, most of the resin base surface is rendered hydrophilic.

The plasma treatment can be any treatment method, provided that metal can be appropriately introduced at the base resin. Examples that can be cited include low-pressure plasma treatments and normal-pressure plasma treatments, but there are no specific restrictions. Normal-pressure plasma treatments (in air, normal pressures (about 1 atm)) are preferred because they allow the treatment of large-size resin bases and allow continuous treatment. Any device can be used for the device whereby the plasma treatment is carried out, and for example, a low-pressure plasma treatment device or other such device can be used. The treatment conditions are set appropriately in accordance with the type, etc., of resin base that is used and the coating containing metal element that is to be formed. The treatment conditions in the low-pressure plasma treatment are preferably a discharge current of 30-200 mA at 20 kHz, a pressure of 0.1-0.3 Pa, a treatment time of 1-30 min, and a reforming reagent such as oxygen, argon, CO₂ or N₂. More preferably, the discharge current is 50-150 mA at 20 kHz, the pressure is 0.1-0.3 Pa, the treatment time is 10-20 min, and the reforming reagent is oxygen, argon, CO₂ or N₂. On the other hand, treatment conditions for normal-pressure plasma treatment are preferably a pulse voltage of 70-100 kV, a discharge space of 1-3 cm and a treatment time of 0.5-100 min. More preferably, the pulse voltage is 80-90 kV, the discharge space is 1-2 cm and the treatment time is 1-30 min. In addition, the treatment temperature for the plasma treatment can be determined appropriately, but normal temperatures (about 20-30° C.) are preferred from the standpoint of resin base stability and workability. The gas in the atmosphere at the time of the plasma treatment can be H, N, O, N₂, O₂, O₃, etc., but oxygen is preferred for normal pressure.

Various methods can be used, without particular restrictions, for the method for introducing groups having ion exchange capacity at the surface of the resin base by means of the plasma treatment. For example, a method can be used wherein introduction is carried out by an appropriate well-known plasma treatment selected in accordance with the type of groups that are to be introduced and the resin that is used. Examples of methods for introducing carboxyl groups as acidic groups are presented below. After placing a polyimide resin film on a turn-table in a microwave low-temperature oxygen plasma treatment chamber, the evacuation pump is operated and the interior of the treatment chamber is evacuated to 0.13 Pa or less. Subsequently, with the vacuum pump operating, oxygen gas is introduced at a rate of 10 mL/min, and the polyimide resin is irradiated for 5 min at a discharge current of 50 (mA), thereby forming carboxyl groups as cation exchange groups at the resin surface. Alternatively, the polyimide resin can be subjected to a high pulse voltage of 70-100 kV in a narrow space of about 1 cm, and treatment can be carried out for 1 min to form carboxyl cation exchange groups at the resin surface.

The ion exchange group introduction agent treatment which is another mode for introducing ion exchange groups is carried out by bringing resin base into contact with ion exchange group introduction agent. The contact method and time, as well as the contact temperature, are determined appropriately so that groups having ion exchange capacity are introduced into the resin base in the desired amount, and so that the resin base is not damaged. An example of a contact method is immersion, but examples are not restricted to this. In process (1) of the present invention, treatment with ion exchange group introduction agent is carried out. Said treatment can be carried out one time, or multiple treatments can be carried out using the same or different introduction agents.

The ion exchange group introduction agent pertaining to the present invention includes any chemical agent that can introduce groups having ion exchange capacity into the resin base. Lewis acids and Lewis bases are preferred, but examples are not limited to these. Preferred examples of ion exchange group introduction agents are sulfuric acid, fuming sulfuric acid, sulfur trioxide, chlorosulfuric acid, sulfuryl chloride and other sulfonation agents, hydrochloric acid, nitric acid, acetic acid, formic acid, citric acid, lactic acid and other acids, sodium hydroxide, potassium hydroxide, ammonia and other alkalis, and amination agents, nitration agents, cyanation agents and oxidation agents. Sulfuric acid, potassium hydroxide and sodium hydroxide are additionally desirable.

When sulfuric acid is used as the ion exchange group introduction agent, the concentration of introduction agent is generally 5-17.5 M, with a concentration of 15-17 M being preferred. If the concentration is less than 5 M, time will be required for treatment, which is undesirable. On the other hand, if the concentration exceeds 17.5 M, the reaction with respect to non-conductive material will be vigorous, and the material structure will be greatly modified, which is undesirable. The treatment temperature is generally 20-90° C., with 40-70° C. being preferred. The treatment time is ordinarily 30 sec to 30 min, with 2 min to 20 min being preferred.

In addition, when alkali solution such as aqueous solution of potassium hydroxide or sodium hydroxide is used as ion exchange group introduction agent, the concentration of alkali solution is 0.1-10 M, with 1-5 M being preferred. If this concentration is 10 M or greater, the resin base will be too strongly attacked, and degradation of the resin base will readily occur. The solvent used for alkali treatment can be water or alcohol. The treatment temperature is 10-80° C., with 25-50° C. being preferred. The treatment time is 30 sec to 10 min, with 2-5 min being preferred. When alcohol is used as solvent, the same effect as when water is used as solvent can be obtained but at a lower alkali concentration, lower temperature and/or shorter times.

Process (2): In the process whereby metal ions are introduced by treating the surface of said base material with liquid containing metal ions, the resin base that has been subjected to the ion exchange group introduction treatment in process (1) above is treated with liquid containing metal ions. By means of this treatment, it is thought that groups having a capacity for ion exchange introduced at the resin base surface in process (1) undergo an ion exchange reaction with metal ions, and metal ions are thereby introduced.

A solution in which the metal element that constitutes the component containing the target metal element is present as metal ions may be used for the liquid containing metal ions. For example, when a metal is to be formed, a solution that contains the desired metal ions is sufficient, and when an alloy is formed, a solution can be used that contains the metal ions of all or some of the metal components that constitute the alloy. For alloys, when a solution is used that contains the metal ions of some of the metal components that constitute the alloy in process (2), it is possible to convert the material to the desired alloy by subsequent treatment with a solution containing the other metal components in a subsequent process.

The metal ions may be complex ions in solution, and in such a case, the complex ions can be any complex anion or complex cation. The liquid containing metal ions is generally used as an aqueous solution. However, depending on the metal ions that are used, the medium can be methanol or other organic solvent, or an organic mixed solvent medium composed of water and organic medium. As necessary, stabilizer for maintaining pH or complexing agent for preventing sedimentation of metal ions can also be blended in the liquid containing metal ions.

The metal element ions cited above can be cited as metal ions contained in the liquid containing metal ions used in the present invention.

In general, the metal ions are blended in the liquid containing metal ions in the form of metal compound or metal salt. There are no particular restrictions on the type of metal salt or metal compound that is used, and an appropriate soluble metal compound or metal salt can be used in accordance with the type of metal. Appropriate examples that can be cited include formate, acetate, chloroacetate, oxalate and other carboxylates, sulfate, sulfite, thiosulfate, fluoride, chloride, bromide, iodide, nitrate, nitrite, bicarbonate, hydroxide, phosphate, phosphite, pyrophosphate, metaphosphate, selenate, thiocyanate, tetrafluoroborate, trisethylenediamine chloride, cyanide, chlorate, perchlorate, formate, perbromate, iodate and periodate. Preferred substances are sulfate, chloride and nitrate, with sulfate being preferred.

The appropriate concentration of metal ion in the liquid containing metal ions is ordinarily about 0.01-1 mol/L, with about 0.03-0.1 mol/L being preferred. In addition, when the target metal coating is in the form of an alloy containing numerous metal components, a solution can be used wherein metal ions are contained at molar ratios that correspond to the molar ratios in the metal component of the final molding. In this case, the total concentration of these multiple metal ions should be such that the aforementioned ranges are satisfied.

The method for treating the resin base with solution containing metal ions has no particular restrictions, and ordinarily, it is preferable to immerse the resin base that has been subjected to the plasma treatment in process (1) into the liquid containing metal ions. This treatment is carried out, for example, at a temperature of about 20-80° C., with about 25-60° C. being preferred, and for a period of about 1-10 min, with about 3-5 min being preferred. In addition, after treating the resin base with liquid containing metal ions, the material can be washed with water and dried as necessary. Preferably, process (3) is carried out after washing with water.

Process (3): In the process in which photocatalyst is introduced into resin base containing introduced metal ions, photocatalyst is introduced into resin base containing introduced metal ions obtained in process (2) above.

The photocatalyst pertaining to the present invention refers to a substance that assumes an excited state when irradiated with electromagnetic radiation, which energy acts on the metal ions that have been introduced into the resin base, thus causing reduction of the metal ions, converting them to metal. In the present invention, there are no particular restrictions on the photocatalyst that can be used in the present invention, provided it is a substance that has the above action. Examples of photocatalyst that can be cited are semiconductors, composites of metals and semiconductors, preferably, metal oxide semiconductors, metal sulfide semiconductors, compound semiconductors composed of elements of group III and group V, and composites of metals and these semiconductors, but examples are not restricted to these. More preferably, the photocatalyst is TiO₂, Pt/TiO₂, SrTiO₃, Pt—RuO₂/TiO₂, Pd/TiO₂, Fe₂O₃/TiO₂, NiO—SrTiO₃, ZnO₂, ZnS, Pt/ZnS, CdS, GaAs, GaP, V₂O₅/SiO₂, Cu⁺/SiO₂, MoO₃/SiO₂, CuMoO₄/SiO₂ or Si—W system oxide, with semiconductor containing Ti being preferred, compounds containing TiO₂ being additionally desirable, and TiO₂ being the most preferred.

The photocatalyst introduction treatment in process (3) can be any method that introduces photocatalyst in the resin base. The treatment can be carried out, for example, by immersing resin base in a liquid containing said photocatalyst as a solution, colloid solution or suspension, or by means of coating or spraying said liquid on the resin base. Methods are not restricted to these. Introduction can also be carried out by causing fine adsorption of solid, or by vapor deposition of photocatalyst component. It is preferable to carry out the introduction treatment by immersing resin base in liquid containing photocatalyst. The liquid containing photocatalyst can be adjusted appropriately in accordance with the type of photocatalyst that is used, and when the photocatalyst is a poorly soluble compound, it is preferable for the photocatalyst to be a colloid solution from the standpoint of capacity for uniform adsorption onto the resin base. When the photocatalyst is used as colloid solution, any substance can be used as the dispersion medium, provided that it does not impede the objectives of the present invention, but water is preferred for the dispersion medium. When the photocatalyst is semiconductor containing TiO₂, it is preferable to use a colloid solution with water as the dispersion medium.

The photocatalyst that is used in the present invention can have any particle diameter without any particular restrictions, provided that it can be introduced into the resin base and has the action of reducing metal ions. The photocatalyst need not be in crystal form, provided that it can be introduced into the resin base and has reduction capacity. For example, when the photocatalyst is TiO₂, the crystal morphology can be anatase, brookite, rutile, or mixtures thereof.

The treatment conditions pertaining to the photocatalyst introduction treatment can be set appropriately in accordance with the type of photocatalyst, the type of introduced metal ions, and the pitch, etc., of the metal pattern that is formed. Regarding the photocatalyst introduction treatment, when the resin base is introduced into a TiO₂ aqueous colloid solution, the amount of the photocatalyst in said colloid solution is generally in the range of 0.01-5 mol/L, with 0.1-1 mol/L being preferred. The treatment temperature is generally 10-50° C., with 20-30° C. being preferred. The treatment time is 30 sec to 30 min, with 1-15 min being preferred. The pH of the colloid solution is generally 1-7, with 1-4 being preferred, and 2-4 being additionally desirable from the standpoint of preventing precipitation of the introduced metal ions as oxides, hydroxides or other compounds, and from the standpoint of preventing elution from the resin base.

Process (4): in the process whereby metal is formed on the surface of the resin base by using electromagnetic radiation to irradiate the resin base containing said introduced photocatalyst, the resin base containing photocatalyst introduced in process (3) above is irradiated with electromagnetic radiation to reduce the metal ions, thus depositing metal on the resin base.

In the present invention, use of the photocatalyst allows the photocatalyst to contribute to the reduction reaction brought about by irradiation with electromagnetic radiation, and there is thus the advantage that the reduction reaction of metal ions to metal effectively occurs even when metal ions alone are used. The metal ions that are introduced into the resin base can undergo reduction to metal by irradiation with electromagnetic radiation having a specific excitation energy, even when photocatalyst is not present. However, when metal ions alone are used, the efficiency of the reduction reaction from metal ions to metals is not necessarily adequate. Although a theoretical grasp cannot be expected, it is thought that as a result of the contribution of the photocatalyst to the reduction reaction resulting from irradiation with electromagnetic radiation in the present invention, the metal ions that have been introduced into the resin base are acted on by energy from the photocatalyst in its excited state caused by electromagnetic irradiation, and that the ions receive this energy in addition to, or instead of, excitation energy directly from the electromagnetic radiation. It is thought that the amount of energy received by the metal ions is thus increased, and that the reduction reaction from metal ions to metal is rendered more efficient.

In particular, when the metal element has a valence of two or greater when ionized, as with Cu, Ni, and Co, for example, a large excitation energy is necessary in the reduction reaction relative to monovalent elements such as Ag, and thus the use of a photocatalyst is advantageous. However, the present invention is not restricted to metal elements having valences of two or greater, and the use of a photocatalyst is also advantageous in cases where a monovalent metal element is used for ionization.

In terms of activating radiation that can be used in the reduction treatment of process (4), any activating radiation such as electromagnetic radiation can be used, provided that it is energy acts on the metal ions that have been introduced into the resin base, thereby reducing the metal ions to metal. However, ultraviolet radiation is preferred. From the standpoint of directly exciting the introduced metal ions in addition to raising the photocatalyst to an excited state, electromagnetic radiation is preferred that has wavelengths that excite the photocatalyst as well as wavelengths that excite the metal ions, and it is preferable for the radiation to be ultraviolet radiation that contains these wavelengths. The power of the electromagnetic radiation is 10 W to 10 kW, but in terms of shortening the treatment time, 100 W to 1 kW is preferred. The electromagnetic radiation irradiation time is 30 sec to 1 min, with 1-10 min being preferred.

As necessary, irradiation with ultraviolet radiation can be carried out after mounting a mask pattern. When a mask pattern is mounted, the metal ions can be selectively reduced in only the desired regions (conductor), thus directly forming a metal pattern. When a metal pattern is formed, it is desirable to irradiate the material with electromagnetic radiation through a mask pattern. The aforementioned mask that is used in irradiation with electromagnetic radiation can be any pattern, and in addition, said mask can be formed from any desired material, provided that it does not allow passage of electromagnetic radiation. It is preferable for the glass mask to be glass because it is not necessary to strip the mask. As a result, running costs are decreased because a stripping liquid is unnecessary. However, materials are not restricted to glass. When a mask is mounted and electromagnetic irradiation is carried out, it is desirable to dry the resin base prior to process (4).

In the present invention, the reduction reaction is carried out with good efficiency due to the contribution of the photocatalyst to the reduction reaction occurring by means of irradiation with electromagnetic radiation. Consequently, it is possible to form a metal pattern with a finer pitch than can be formed directly by means of irradiation with electromagnetic radiation. For example, pitches of metal patterns that can be produced by the method of the present invention are 100-10 μm, with 75-20 μm being preferred, 50-20 μm being additionally desirable, and 30-20 μm being even more desirable.

In the present invention, metal is deposited by means of the reduction treatment in process (4), but photocatalyst is introduced onto the resin base. For this reason, the photocatalyst that has been introduced in process (3) is present on or in the metal on the resin base of the composite material immediately following process (4). The amount of photocatalyst present immediately following process (4) depends on the amount introduced in process (3), and a discussion has already been presented concerning this amount.

The method of the present invention can also include, after process (3) and before process (4), an optional process (5) for introducing reduction agent into the resin base after introduction of photocatalyst.

In the present invention, process (5) is preferably carried out in order to accelerate the reduction reaction when the rate of the reduction reaction from metal ions to metal is slow in the reduction treatment carried out by irradiation with electromagnetic radiation. For example, when a metal element is used that has a valence of two or greater when ionized, as with Cu, Ni and Co, for example, greater excitation energy is required in the reduction reaction relative to monovalent elements such as Ag. Although it is desirable to carry out process (5), processes are not restricted to this one, and process (5) can also be carried out when a monovalent metal element is used for ionization, such as Ag.

There are no particular restrictions on the reduction agent in process (5), provided that it can reduce metal ions and cause the deposition of metal. Ordinarily, the solution containing reducing agent is used as an aqueous solution. Examples of reducing agents used in such a case that can be cited include sodium borohydride, dimethylaminoborane (DMAB), trimethylaminoborane (TMAB), hydrazine, formaldehyde, formic acid and derivatives of these various compounds, sodium sulfite and other sulfites, and sodium hypophosphate and other hypophosphites. Examples are not restricted to these, and any well-known reducing agent can be used. The concentration of reducing agent in the aqueous solution is ordinarily about 0.001-0.1 mol/L, with about 0.005-0.01 mol/L being preferred.

Substances that can be used as reducing agents are selenium urea, arsenite, antimony (III) chloride and tellurium chloride, and when these reducing agents are used in the reduction of metal ions that have been introduced chemically onto acidic groups, the metal component in the reducing agent can form an alloy with the reduced metal component; specifically, Se when selenium urea is used, As when arsenite is used, Sb when antimony (III) chloride is used, or Te when tellurium chloride is used. The conditions of use of reducing agent such as selenium urea and arsenite can be the same as when the above various reducing agents are used, and these can be used in conjunction with the aforementioned various reducing agents. In particular, when selenium urea is used in conjunction with other reducing agents, the stability of selenium urea in the reducing agent solution can be improved. Using selenium urea in conjunction with other reducing agents is thus preferred.

With the reduction treatment carried out using the aqueous solution containing the aforementioned reducing agent, when sufficient metallization is difficult, a reducing treatment can be carried out using organic solvent solution containing reducing agent with stronger reducing capacity. Examples of reducing agents that can be used with organic solvents include metallic Li, Na and K (solvent: liquid ammonia, amines, etc.), trialkylaluminum (solvent: dioxane, toluene, tetrahydrofuran, etc.) and tri-n-butyltin and other tin hydride compounds (solvent: ethylene-based solvent, benzene, toluene, etc.). When the reducing treatment is carried out using organic solvent solutions of these reducing agents, it is desirable to determine the reducing agent concentration and reduction conditions appropriately in order to perform sufficient metallization in accordance with the type of metal salts that are to be reduced.

Introduction of reducing agent in process (5) is carried out by bringing about contact between the aforementioned reducing agent solution and the resin base after introduction of the photocatalyst. Examples include coating or spraying the aforementioned reducing agent solution onto the resin base, or immersing the resin base in reducing agent liquid, but examples are not restricted to these. From the standpoint of preventing release of introduced photocatalyst, it is preferable to coat or spray the aforementioned reducing agent solution on the resin base. In addition, prior to process (5), the resin base can be washed with water and/or dried, and prior to process (5), it is desirable to wash the resin base with water and dry it.

When desired, the method of the present invention can include, subsequent to process (4), process (6) in which introduced metal element is removed in the regions not irradiated with electromagnetic radiation.

In the method of the present invention, the metal ions are introduced into the resin base in process (2), and the introduced metal ions are then reduced to metal in the regions irradiated with electromagnetic radiation in process (4). In the regions not irradiated with electromagnetic radiation, the introduced metal ions are not converted at all, and remain as metal ions over the course of processes (1)-(4), for example, beginning with process (2) (and including process (5), when carried out). The ions are converted to metal first by the reduction reaction carried out by the reducing agent in process (5). In addition, side-reactions can occur in any of the processes thereby converting the metal into metal compounds, and thus the metal is present on the resin base in various forms. The regions that are not irradiated with electromagnetic radiation are regions on which metal is not present on the composite, or specifically, regions corresponding to the insulating pattern. For this reason, the metal element remaining in the regions not irradiated with electromagnetic radiation can have a detrimental influence when the composite material is used. Thus, it is desirable to remove, from the resin base, metal elements present in the regions not irradiated with electromagnetic radiation deriving from the metal ions introduced in process (2). The method of the present invention thus preferably includes a process (6). There are cases where, by means of the treatment in process (6), all or some of the photocatalyst that has been introduced into the resin base can be removed.

In process (6), removal of metal element can involve any method, provided that the introduced metal element remaining in the regions not irradiated with electromagnetic radiation can be removed. For example, the resin base can be brought into contact with dilute nitric acid, dilute hydrochloric acid, dilute sulfuric acid and other dilute acids, dilute sodium hydroxide aqueous solution, dilute potassium hydroxide aqueous solution and other dilute alkalis, but methods are not restricted to these. The method for bringing the resin base into contact with dilute acid or dilute alkali, for example, can involve immersion in dilute acid or dilute alkali liquid, but examples are not restricted to this. If the conditions for the removal treatment are too extreme, the metal in the regions irradiated with electromagnetic region that is to serve as the metal pattern will be removed, but if the conditions are inadequate, metal element will remain in the regions not irradiated with electromagnetic radiation. Consequently, the conditions are determined appropriately. For example, the concentration of acid or alkali is 0.1-5%, with 0.5-2% being preferred, and the immersion time is generally 0.5-5 min, with 0.5-2 min being preferred.

In the present invention, the various processes (1)-(6) above can be carried out once, or any process can be repeated multiple times.

The composite material obtained in processes (1)-(4) (including process (5)and/or process (6) as desired), can be subjected to any plating treatment. Examples of said plating treatment include electrolytic metal plating, electroless melt plating and substitution metal plating, and any desired amount of any metal can be deposited by using any plating treatment. Multiple plating treatments can also be carried out. By means of said plating treatment, the composite material of the present invention can be formed from resin base and not just one, but more than one, plated metal layers.

The composite material of the present invention is particularly useful in applications in which a fine metal pattern and improved binding strength is desired, for example, copper-clad laminated boards, TAB (tape automated bonding), FPCs (flexible printed circuits) and CSPs (chip size packages), but examples are not restricted to these, as the material can be used in any application in which composite materials comprising resin base and metal are used.

The present invention is described below by means of working examples, but said working examples do not limit the scope of the present invention.

Peel Strength Measurement Method

After forming a thin film containing metal component by means of the method of the present invention, a 10 μm copper coating is formed by thick electroless copper plating. After annealing for 1 h at 120° C., the coating is cut to a width of 1 cm, and a test (180° peel strength test) is carried out using a tensile tester to peel the coating perpendicularly at a rate of 10 mm/min.

Thick Electroless Copper Plating Treatment

Thick electroless copper plating was carried out on the composite material using the electroless copper plating bath and plating conditions indicated below.

After treating the composite material for 1 h in 10% sulfuric acid at 25° C. after pattern formation, the material was washed with water for 1 min at room temperature, and was subjected to a 2 h electroless plating treatment at 65° C. in the thick electroless copper plating bath indicated below. After washing with water for 1 min at room temperature and drying, a composite material having a copper layer of the desired thickness was obtained.

Thick Electroless Copper Plating Bath Composition

CuS0₄.5H₂O: 12 g/L

HCHO (37% aqueous solution): 25 g/L

EDTA-2Na: 50 g/L

NaOH: 12 g/L

CN⁻: 5 mg/L

2,2′-Dipyridyl: 20 mg/L

PEG: 10 mg/L

Surface Resistance

The surface resistance (Ω/) used in the present invention is calculated by the following formula for a case where the region to be measured is coated with a conductive coating at a width of 1 mm and a length of 5 mm, and the resistance R is measured for a region that is not coated with conductive coating (region of length 5 mm).

Surface Electrical Resistance (Ω/)=R (Ω)×Width (mm)/Length (mm)

### WORKING EXAMPLE 1

Polyimide resin (Toray DuPont) was immersed for 4 min in 1 M sodium hydroxide aqueous solution at 45° C. After washing with water, the material was immersed for 5 min in 0.05 M copper sulfate solution at 25° C. in order to introduce copper ions into the polyimide resin surface. Next, after washing with water, the material was immersed for 10 min in 0.5 M TiO₂ colloid solution (Kanto Kagaku) at 25° C. to introduce TiO₂ colloid at the surface. After washing with water and drying, the surface was then coated with 0.05 M sodium borohydride solution. The resin was then covered with a quartz glass mask, and was irradiated for 5 min at 500 W, 1 atm and 25° C. with ultraviolet radiation from a high-pressure mercury lamp power source. Subsequently, the material was immersed for 1 min in 1% nitric acid solution at 25° C. in order to remove copper ions from the un-reduced regions outside the pattern, thus obtaining metal pattern conductor with a thickness of 100 μm. The surface resistance was 0.1 Ω/or less.

Next, said composite material was subjected to a thick electroless plating treatment, and copper was thus deposited at the required film thickness (10 μm) only in the metal pattern regions. In addition, the binding strength between the formed copper pattern and resin was 10 N/cm.

### WORKING EXAMPLE 2

Polyimide resin was immersed for 4 min in 16 M sulfuric acid solution at 50° C., and subsequently, was washed with water and immersed for 2 min in 1 M sodium hydroxide solution at 25° C. Subsequently, the material was washed with water and immersed for 5 min in 0.05 M copper sulfate solution at 25° C., thus introducing copper ions into the polyimide resin surface. After washing with water, the material was immersed for 10 min in 0.5 M TiO₂ colloid solution at 25° C. in order to introduce TiO₂ colloid at the surface. After then washing with water and drying, the surface was coated with 0.05 M sodium borohydride solution, the resin was covered with a quartz glass mask, and the copper was reduced by irradiation with ultraviolet light for 5 min at 500 W, 25° C. and 1 atm using a high-pressure mercury lamp power source. Subsequently, the material was immersed for 1 min in 1% nitric acid solution at 25° C. to remove the copper element in the unreduced regions other than the pattern, thus obtaining a metal pattern conductor with a thickness of 100 μm. The surface resistance was 0.1 Ω/or less.

Next, said composite material was subjected to a thick electroless plating treatment, and copper was thus deposited at the required film thickness (10 μm) only in the metal pattern regions. In addition, the binding strength between the formed copper pattern and resin was 10 N/cm.

### WORKING EXAMPLE 3

Polyimide resin was irradiated for 5 sec in the presence of oxygen at 25° C., 1 atm and 30 kW using a normal-pressure plasma device (Nippon Paint K.K.), thereby introducing carboxyl groups as cation exchange groups. Subsequently, the material was immersed for 5 min in 0.05 M copper sulfate solution at 25° C., thus introducing copper ions into the polyimide resin surface. After washing with water, the material was immersed for 10 min in 0.5 M TiO₂ colloid solution at 25° C. in order to introduce TiO₂ colloid at the surface. After then washing with water and drying, the surface was coated with 0.05 M sodium borohydride solution, the resin was covered with a quartz glass mask, and the copper was reduced by irradiation with ultraviolet light for 1 h at 140 W, 25 C and 1 atm using a low-pressure mercury lamp power source. Subsequently, the material was immersed for 1 min in 1% nitric acid solution at 25° C. to remove the copper ions in the unreduced regions other than the pattern, thus obtaining a metal pattern conductor with a thickness of 100 μm. The surface resistance was 0.1 Ω/or less.

Next, said composite material was subjected to a thick electroless plating treatment, and copper was thus deposited at the required film thickness (10 μm) only in the metal pattern regions. In addition, the binding strength between the formed copper pattern and resin was 10 N/cm.

### WORKING EXAMPLES 4-6

In Working Examples 4-6, formation of a copper pattern was carried out in the same manner as in Working Examples 1-3, with the exception that the sodium borohydride reducing agent coating treatment was not carried out.

After irradiating with ultraviolet light, deposition of copper was attempted on the resin base, but the pattern clarity was inferior relative to Working Examples 1-3.

### COMPARATIVE EXAMPLES 1-3

In Comparative Examples 1-3, formation of a copper pattern using the same methods as in Working Examples 1-3 was attempted, with the exception at the TiO₂ colloid introduction treatment and sodium borohydride reducing agent coating treatment were not carried out.

After irradiation with ultraviolet light, deposition of metallic copper on the resin base was not seen, and the resin base was discolored black. It is thought that copper ions were not reduced to metallic copper due to insufficient reduction capacity.

As is clear from Working Examples 1-6 and Comparative Examples 1-3 above, reduction to metallic copper is possible in direct metallization methods due to the contribution of TiO₂ photocatalyst in the reduction reaction, even with copper ions that have been difficult to reduce in the past solely by irradiation with ultraviolet light. In addition, the use of photocatalyst and reducing agent in conjunction makes it easy to form a copper pattern directly on resin base, which has been problematic in the past with direct metallization methods.

As stated above, preferred resin composite materials of the present invention have a smooth resin base surface and superior binding between metal and resin base, thus allowing for a finer metal pattern to be formed. In addition, the composite material of the present invention is useful in that it can be more easily and efficiently manufactured than with electroless plating treatments. The use of photocatalyst in the present invention also allows for the direct formation of a metal pattern on a resin base because metal ions can be reduced with good efficiency, even when metal ions having valences of two or greater are used in direct metallization methods carried out by irradiation with ultraviolet radiation. The present invention also allows the manufacture of composite material with good efficiency by means of using a reducing agent in conjunction with electromagnetic irradiation.

All documents mentioned herein are incorporated herein by reference in their entirety.

The foregoing description of the invention is merely illustrative thereof, and it is understood that variations and modifications can be made without departing from the spirit or scope of the invention as set forth in the following claims.

What is claimed is:

1. A method for forming a composite material, comprising (1) a process for introducing ion exchange groups at the surface of a resin base, (2) a process for introducing metal ions by treating the surface of said resin base with liquid containing metal ions, (3) a process for introducing photocatalyst into the resin base having the introduced metal ions, and/or (4) a process for forming metal on the surface of a resin base by using electromagnetic radiation to irradiate the resin base having said introduced photocatalyst.

2. The method for forming a composite material according to claim 1, which includes a process in which reducing agent is introduced into the resin base containing introduced photocatalyst after process (3) but before process (4).

3. The method for forming a composite material according to claim 1 or 2, which includes a treatment process for removing the introduced metal element in regions not irradiated with electromagnetic radiation after process (4).

4. The method for forming a composite material according to any of claims 1-3, wherein irradiation with electromagnetic radiation is carried out through a master pattern, thus forming a metal pattern.

5. The method for forming a composite material according to claim 4, wherein the valence of the metal ions introduced into the resin base is two or greater.

6. A composite material having metal on a resin base obtainable by the method of claim 1 or 18, wherein the metal comprises photocatalyst.

7. The composite material of claim 6, wherein the amount of photocatalyst per unit surface area of metal covering the resin base is 10⁻¹⁰ to 10⁻³ mg/cm².

8. The composite material of claim 6 or 7, wherein the joining strength between resin base and metal is 5-15 N/cm.

9. The composite material of claim 8, wherein the average surface roughness of the resin base at the joining surface with the metal is 1 μm or less.

10. The composite material of any one of claims 6 through 9, wherein the metal is a metal selected from V, Cr, Mn, Fe, Co, Ni, Cu, Ga, As, Se, Mo, Ru, Rh, Pd, Ag, Cd, In, Sb, Te, Os, Ir, Pt, Au, Hg, Pb, Bi and alloys thereof.

11. The composite material of any one of claims 6 through 10, wherein the photocatalyst is one or more substances selected from a group comprising TiO₂, Pt/TiO₂, SrTiO₃, Pt—RuO₂/TiO₂, Pd/TiO₂, Fe₂O₃,/TiO₂, NiO—SrTiO₃, ZnO₂, ZnS, Pt/ZnS, CdS, GaAs, GaP, V₂O₅/SiO₂, Cu⁺/SiO₂, MoO₃/SiO₂, CuMoO₄/SiO₂ and Si—W system oxide.

12. A composite material obtained by carrying out an additional plating treatment on the composite material according to any of claims 6-11.

13. A method for forming a composite material, comprising
introducing ion exchange groups to a resin base;
introducing metal ions by treating the resin base with liquid containing metal ions;
introducing photocatalyst into the resin base having the introduced metal ions; and
forming metal on the surface of a resin base by exposing the resin base having the photocatalyst with radiation activating for the photocatalyst.

14. The method of claim 13 wherein the reducing agent is introduced into the resin base containing introduced photocatalyst.

15. The method of claim 13 or 14 wherein the introduced metal element in regions not irradiated with electromagnetic radiation is removed thermally.

16. The method of any one of claims 13 through 15 wherein irradiation with electromagnetic radiation is carried out through a master pattern, thereby forming a metal pattern.

17. The method of claim 16 wherein the valence of the metal ions introduced into the resin base is two or greater.

18. A method for forming a composite material, comprising:
a) introducing ion exchange groups to a resin layer,
b) treating the resin with metal ions;
c) treating the resin with photocatalyst, and
d) forming metal on the resin.

19. The method of claim 18 wherein steps a) through d) are conducted sequentially.

20. The method of claim 18 further comprising exposing the resin having photocatalyst with radiation activating for the photocatalyst.

21. The method of any one of claims 18 through 20 wherein a reducing agent is introduced into the resin containing photocatalyst.

22. The method of any one of claims 18 through 21 wherein metal in resin regions not irradiated with radiation is removed.

23. The method of any one of claims 18 through 22 wherein the resin is exposed to patterned radiation.

24. The method of any one of claims 18 through 23 wherein the valence of the metal ions introduced into the resin is two or greater.
